(19) United States
(12) Patent Application Publication
(10) Pub. No.: US 2012/0318788 A1
(43) Pub. Date: Dec. 20, 2012

(54) Mid-Section Separable and Nestable Bottle

(76) Inventor: MICHAEL AUSTIN, IRVINE, CA (US)

(21) Appl. No.: 13/163,475

(22) Filed: Jun. 17, 2011

(51) Int. Cl. B65D 8/04; B67D 7/22; B65D 51/18

(52) U.S. Cl. 220/4.28; 220/254.9; 220/259.3; 222/36

(57) ABSTRACT

Improvements in a nestable sports bottle are disclosed to allow a person to keep track and consume eight ounces of water eight times a day. Accounting for the eight bottles is made with an adjustable indicator ring that is located on the bottle to identify how many times the bottle has been filled and consumed. The bottle is separable in two portions to improve the ability to clean the interior of the bottle and where the separable sections can nest inside, and be secure to one another for reduced storage space. The bottle has a closure to open and close the bottle with one hand using their mouth. The bottle has a tether loop to retain the housing(s) and prevents accidental dropping, loss or to carry the bottle with one finger. The cap can be removed to fill the bottle through the opening created by the removed cap.

### CROSS REFERENCE TO RELATED APPLICATION

Not Applicable

### STATEMENT REGARDING FEDERALLY SPONSORED RESEARCH OR DEVELOPMENT

Not Applicable

THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a sports bottle. More particularly, the present mid-section separable and nestable sports bottle provides an indicator to record the amount of fluid that have been consumed and the parts are separable for more complete cleaning and storing where the upper portion of the bottle can be separated from the bottom portion and inverted for storage and air drying in the separated portions.

2. Description of Related Art Including Information Disclosed Under 37 CFR 1.97 and 1.98

The body's principal chemical component is water and makes up about 60 percent of your body weight. Every system in your body depends on water. For example, water flushes toxins out of vital organs, carries nutrients to your cells and provides a moist environment for ear, nose and throat tissues. A lack of water can lead to dehydration, a condition that occurs when you don't have enough water in your body to carry out normal functions. Even mild dehydration can drain your energy and make you tired. Every day a body loses water through your breath, perspiration, urine and bowel movements. A person must replenish its water supply by consuming beverages and foods that contain water.

In general, doctors recommend about 8 cups of water each day or the “8×8 rule” to drink eight, 8-ounce glasses of water a day (about 1.9 liters). The rule could also be stated, “Drink eight 8-ounce glasses of fluid a day,” as all fluids count toward the daily total. Many people use this easy-to-remember rule as a guideline for how much water and other fluids to drink. A number of patents have been filed for drinking container, but few address accounting for the 8×8 rule. Reusing drinking containers also requires cleaning both the outside and the inside of the containers to kill harmful bacteria. Several products and patents have been filed to try and address these issues. Exemplary examples of patents covering these products are disclosed herein.

U.S. Pat. No. 4,877,119 issued to Jaennette T. Hosking on Oct. 31, 1989 and U.S. Pat. No. 6,237,269 issued to Stephen M. Key on May 29, 2001 both disclose changeable labeling systems for cups or bottles. Neither of these products disclose using the label for counting the number of times the glass or bottle is filled and nor do they disclose a separable container or the ability to nest the two parts together. They are also not a ratcheting ring type system.

Published application 2006.0254936 that was published on Nov. 16, 2006 to Dwayne R. Corbitt et al., and Published application 2010-0326945 that was published on Dec. 30, 2010 to Je-Woo Yu both disclose separable containers that can be opened for easier cleaning. Neither of these containers provides a measurement mechanism nor a counting system to determine how many times fluid within the container has been consumed.

U.S. Pat. No. 2,752,971 was issued on Jul. 3, 1956 to E. S. Tupper, U.S. Pat. No. 3,820,692 was issued on Jun. 28, 1974 to James B. Swett et al., and U.S. Pat. No. D565,353 was issued on Apr. 1, 2008 to Donna Roth all disclose shakers or bottles that are separable for easy cleaning. None of these patents disclose that the halves can be nested, nor do these containers provide a measurement or a counting system to determine how many times the contents of the container has been consumed.

What is needed is a separable sports bottle that allows the separable members to be easily cleaned and nested for storage. The sports bottle should also include a counting system to allow a consumer to ensure they consume their daily fluids.

### BRIEF SUMMARY OF THE INVENTION

It is an object of the mid-section separable and nestable bottle to have an openable closure to allow for access to fluids within the bottle. The openable closure allows a user to open the bottle by grasping the bottle in one hand and placing the cap in one's mouth and pulling open the closure when grasped behind the teeth. This allows the bottle to be opened with only one hand, thereby allowing the user to remain balanced and or controled with their other hand. The closure can be closed by simply pressing onto the top of the closure to prevent spillage.

It is an object of the mid-section separable and nestable bottle to have a cap retainer that keeps a removable cap with the housing and prevents accidental misplacement, dropping or loss of the removable cap. The removable cap is retained onto the top of the bottle with a tether, string, strap or similar retention mechanism. The cap can be removed to fill the bottle through the opening created by the removed cap. The bottle itself may also contain a loop to secure the bottle which allows the user to carry the bottle with one finger.

It is another object of the mid-section separable and nestable bottle to be separable for cleaning. The ability to separate the bottle allows access to all or nearly all of the interior cavity. When the bottle is separated the two portions can be placed in a dishwasher or cleaned by hand. With a typical sports bottle access to the interior is limited by the size of the filling or drinking opening and is often too tall for dishwasher and hand cleaning. The bottle can be separable at the middle or justified off of center.

It is another object of the mid-section, separable and nestable bottle to be nestable where the separable sections can nested inside one another. This provides reduced storage space and allows more sports bottles to be stored in the same area. The sides of the sports bottle sections can also be tapered or drafted to allow the pieces to nest more tightly so they snap and stay in place for drawer storage. By allowing the bottle to be separated and nested, the inverted top is placed inside the bottom portion, not only is space saved, but the separated parts are kept together. This eliminated the problem of locating compatible parts in a drawer or cabinet.

It is still another object of the mid-section separable and nestable bottle to have an adjustable indicator to identify how many times the bottle has been filled and consumed. The neck of the sports bottle has a ring and indicator. The ring has numbers based upon the amount of fluid within the bottle. If the bottle has eight ounces of fluid then the indicator ring would have numbers from one to seven or eight to indicate consumption of eight, eight ounce glasses of water that should be consumed by a person each day. If the bottle has a volume of 16 ounces then the indicator will count for a total of four consumptions.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an exploded perspective view of the mid-section separable and nestable bottle.

FIG. 2 shows a side view of the mid-section separable and nestable bottle in the assembled orientation.

FIG. 3 shows a side view of the mid-section separable and nestable bottle with the parts nested.

FIG. 4 shows a side sectional view with the parts nested.

FIG. 5 shows a perspective side view of the mid-section separable and nestable bottle with the nested features visible through the bottom portion.

FIG. 6 shows a perspective view of the mid-section separable and nestable bottle with the housings nested showing the bottom of the bottle.

### DETAILED DESCRIPTION OF THE INVENTION

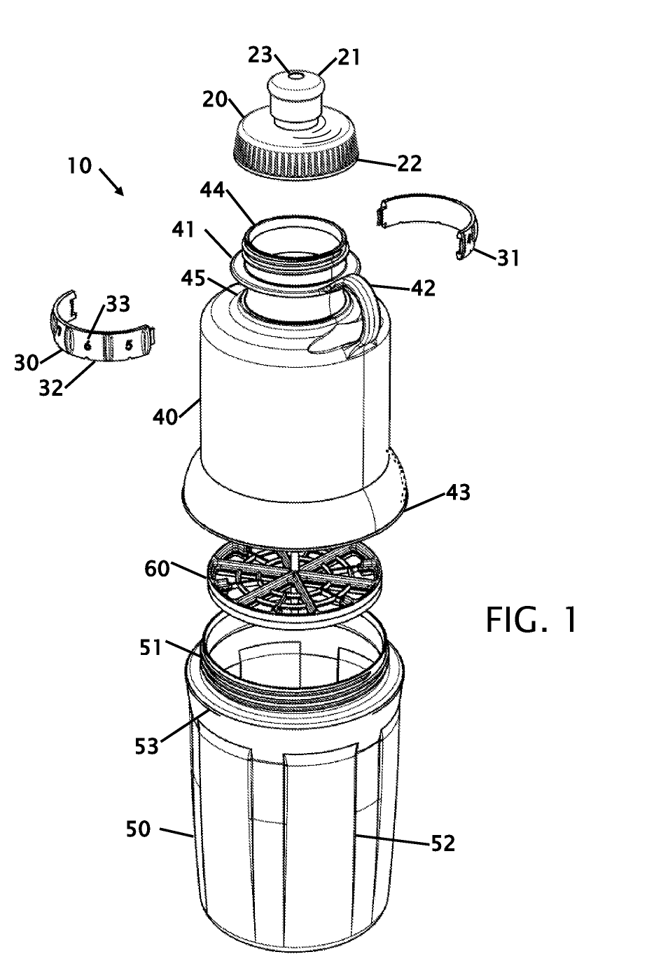

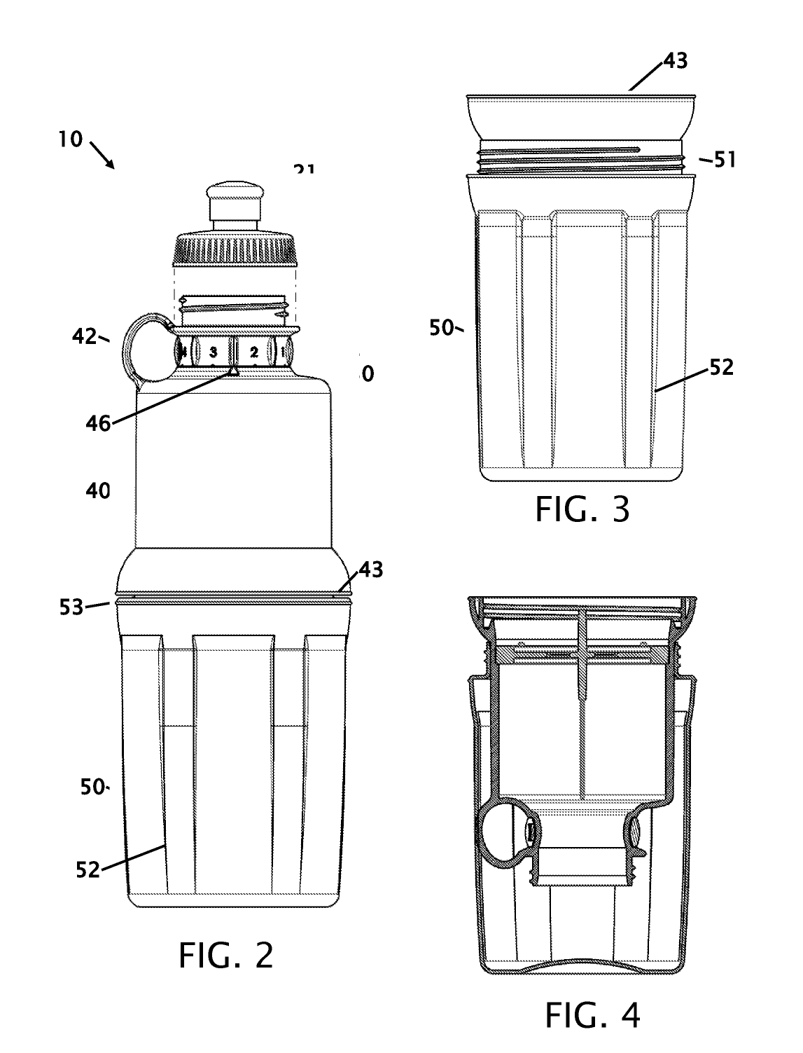

FIG. 1 shows an exploded perspective view of the mid-section separable and nestable bottle 10, FIG. 2 shows a side view of the mid-section separable and nestable bottle 10 in the assembled orientation. The sports bottle 10 is shown in exploded view to show the components separately as they might appear before they are assembled in use. In the preferred embodiment, the cap 20 of the sports bottle has a cap 20 that can be threaded 41, snapped or otherwise secured onto the top portion 40 of the bottle 10. An openable tip 21 allows a user to open the bottle 10 by inserting the bottle tip 21 into a mouth and grasping the tip 21 behind the teeth and pulling slightly on the bottle 10 to open the tip 21 and allow fluid from within the bottle 10 to flow out of the opening 23. The tip 21 is closed by pressing on the tip 21 to prevent further fluid flow out of the opening 23.

The cap 20 has internal threads (not shown) that allow the cap 20 to be threaded onto the top housing 40. The cap 20 has ribs 22, knurling or other features that makes grasping the cap 20 easier. The neck 45 of the bottle 10 has an indicator ring 30. In this preferred embodiment the ring 30 is made from two pieces 31 and 32. The two pieces 31 and 32 connect together by snap fit, compression fit, gluing, ultrasonic welding or other bonding methods that keep the two pieces connected and retained on the neck 45. The ring 30 has indicia 33 to indicate the number of time the bottle 10 has been filled and or consumed. In one preferred embodiment the bottle contains eight or 16 ounces of fluid and if the bottle is filled and consumed eight times it would constitute consumption of 64 ounces of fluid which is the recommended consumption of water per day or eight ounces eight times a day to satisfy the 8×8 rule. The ring 30 shown has numbering of 1 to 7 or 1 to 8. If the bottle contains 16 ounces of fluid the ring 30 may count from 0 to 4. The internal volume is preferably between seven and 18 ounces to accommodate variations in manufacturing and filling with the idea volume(s) being eight and 16 ounces, but other variations are contemplated that would count up to 64 ounces of consumption in a day.

When the bottle is first filed each day the ring 30 is set to zero or one by placing the number zero (or one) on the indicator pointer 46. Each time the bottle is consumed, a person turns the ring to increments the count on the pointer 46. This process continues until the required or desired amount of fluid is consumed. The opening 44 of the top housing 40 is large enough to allow the bottle to be placed under a faucet to allow the bottle 10 to be quickly filed. The top housing 40 has a lip, flange or hilt 41 to prevent over threading of the top 20 onto the upper housing 40 and also makes the bottle easier to grasp between two finger. An optional tether can connect the top 20 to the top of the bottle. A ring 42 allows the bottle to be connected and secured to prevent accidental dropping of the bottle 10, or carried with one finger or on a clasp. The two housings meet together where the top portion 40 closes on the bottom portion 50 at 43 and 53 accordingly. The housings may seal with a compliant gasket, or the housings may close sufficiently to prevent leakage. The body of the top housing 40 is constructed to a smaller diameter than the inside diameter of the bottom housing 50 to allow for the top portion 40 to be inverted and snapped into the bottom housing or portion 50.

The housings may split at the center or middle of the housings, as shown in this embodiment, but may split above or below the middle without detracting from the overall disclosed and claimed function of the sports bottle. The bottom housing 50 has a threaded portion 51 that secures the top housing 40 to the bottom housing 50. A complimentary threaded coupling is on the top housing 40. In the preferred embodiment, threaded couplings are shown and described, but other couplings including but not limited to bayonet, snap, slip or compression fit may be used. While the male thread is shown in the bottom housing 50 and the top housing 40 is shown with female threads, the threads can exist in the opposite sides. The bottom housing 50 has a textured or contoured 52 housing to make the bottle easier to grip for holding or screwing together and apart.

An internal mixer 60 allows powdered or other similar material to be broken apart when the bottle is shaken. The internal mixer 60 has a series of webbed fingers whereby material that comes in contact with the webs are broken into smaller pieces to be more thoroughly dissolved. This is particularly useful when powdered is mixed with water, energy drinks or juice.

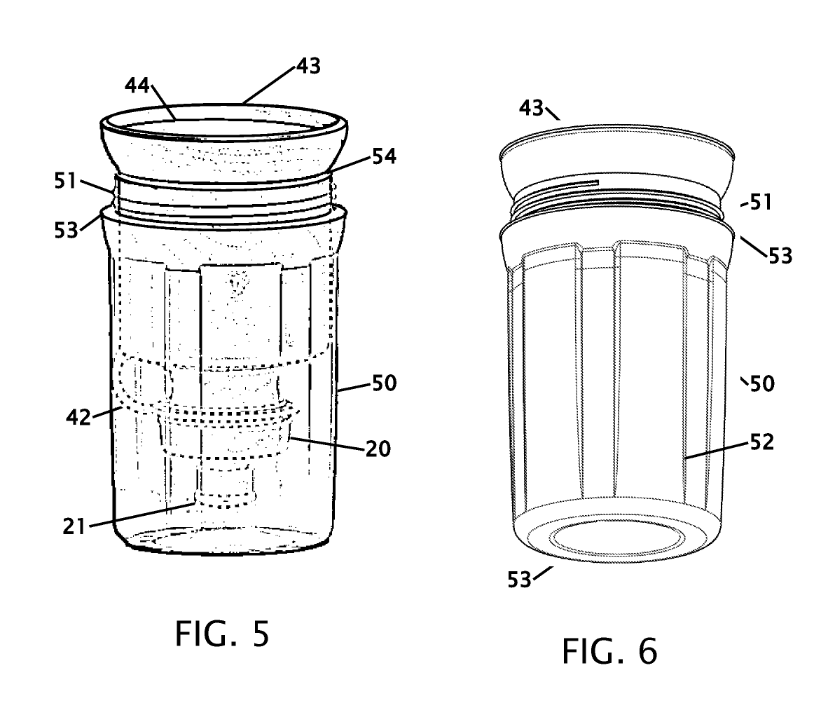

FIG. 3 shows a side view of the mid-section separable and nestable bottle with the parts nested, FIG. 4 shows a side sectional view with the parts nested, FIG. 5 shows a perspective side view of the mid-section separable and nestable bottle with the nested features visible through the bottom portion and FIG. 6 shows a perspective view of the mid-section separable and nestable bottle with the housings nested showing the bottom of the bottle. When the two parts are separated they can be separately washed by hand or in a dishwasher. Because the parts are separable the interior of the bottle can be more completely scrubbed and washed. It is contemplated that the housings may be fabricated in a transparent material. In the preferred embodiment the housings are made from plastic such as ABS, PVC, PETG, polycarbonate, polypropylene, polyethylene and other materials that are compliant, but can also be fabricated from other materials such as but not limited to aluminum, stainless steel or glass. Some components may be made from one material, while other components are made from other materials. The components can be made using various methods including but not limited to, injection molding, blow molding and roto-molding.

In FIG. 4 the bottom housing 50 is shown semi-transparent. Portions of the top of the top housing are visible through the bottom housing 50. Through the bottom housing 50 the closure tip 21 is visible on the cap 20. The top 20 is screwed or otherwise secured to the top housing 40 but can be loose and will not be misplaced as the top and bottom are snapped together. This is especially good for air drying. The cap 20 can be left off of the top housing 40 to allow for more through air drying within the bottom housing 50. Variable amounts of opacity for the top and or bottom are contemplated. The tethering ring 42 is configured to fit within the lower housing 50. An inset seal 44 or taper from the outer lip 43 closes on the bottom housing 50. The lip of the bottom housing 50 has a snap retainer 54 (as shown in FIG. 5) that temporally secures the top housing 40 onto the bottom housing 50.

Thus, specific embodiments of a mid-section separable and nestable bottle have been disclosed. It should be apparent, however, to those skilled in the art that many more modifications besides those described are possible without departing from the inventive concepts herein. The inventive subject matter, therefore, is not to be restricted except in the spirit of the appended claims.

1. A mid-section separable and nestable bottle comprising:
a bottom housing;
a top housing that is separable and securable to said bottom housing;
a drinking opening, and
said top housing further including an incremental indicator indicia to identify the number of time contents of said bottle was consumed.

2. The mid-section separable and nestable bottle according to claim 1 wherein said bottom housing, said top housing and said incremental indicator indicia is made from plastic, metal or glass.

3. The mid-section separable and nestable bottle according to claim 1 wherein said bottom housing and said top housing creates and internal volume of between seven and 18 ounces.

4. The mid-section separable and nestable bottle according to claim 1 wherein said incremental indicator indicia counts up to eight fillings of said nestable sports bottle.

5. The mid-section separable and nestable bottle according to claim 1 wherein said incremental indicator indicia is rotatable around said top housing or said bottom housing.

6. The mid-section separable and nestable bottle according to claim 1 wherein said bottom housing and said top housing are configured to nest at least partially together both in a use mode and in a drying mode.

7. A mid-section separable and nestable bottle comprising:
a bottom housing;
a top housing that is separable and securable to said bottom housing;
a drinking opening, and
said top housing and said bottom housings are configured to nest at least partially together.

8. The mid-section separable and nestable bottle according to claim 7 wherein said bottom housing and said top housing is made from plastic, metal or glass.

9. The mid-section separable and nestable bottle according to claim 7 wherein said bottom housing and said top housing creates and internal volume of between seven and 18 ounces.

10. The mid-section separable and nestable bottle according to claim 7 wherein said bottom housing and said top housing are configured to nest at least partially together.

11. The mid-section separable and nestable bottle according to claim 7 that further including an incremental indicator indicia to identify the number of time contents of said bottle was consumed.

12. The mid-section separable and nestable bottle according to claim 11 wherein said incremental indicator indicia counts up to at least four fillings of said nestable sports bottle.

13. The mid-section separable and nestable bottle according to claim 11 wherein said incremental indicator indicia is rotatable around said top housing or said bottom housing.

14. A mid-section separable and nestable bottle comprising:
a bottom housing;
a top housing;
a drinking opening, and
said top housing further including an incremental indicator indicia to identify the number of time contents of said bottle was consumed

15. The mid-section separable and nestable bottle according to claim 14 wherein said bottom housing, said top housing and said incremental indicator indicia is made from plastic, metal or glass.

16. The mid-section separable and nestable bottle according to claim 14 wherein said bottom housing and said top housing creates and internal volume of approximately eight or 16 ounces.

17. The mid-section separable and nestable bottle according to claim 14 wherein said incremental indicator indicia counts up to at least four fillings of said nestable sports bottle.

18. The mid-section separable and nestable bottle according to claim 14 wherein said incremental indicator indicia is rotatable around said top housing or said bottom housing.

19. The mid-section separable and nestable bottle according to claim 14 wherein said top housing and said bottom housings are temporally separable and securable together both in a use mode and in a drying mode.

20. The mid-section separable and nestable bottle according to claim 19 wherein said bottom housing and said top housing are configured to nest at least partially together.
